(19) United States
(12) Patent Application Publication
(10) Pub. No.: US 2024/0403110 A1
(43) Pub. Date: Dec. 5, 2024

(54) ADVANCED PLANNING AND EXECUTION OF ENTITY CLOSES

(71) Applicant: SAP SE, Walldorf (DE)

(72) Inventors: Thomas Luecking, Bruchsal (DE); Brigitte Reinelt, Wiesloch (DE)

(73) Assignee: SAP SE, Walldorf (DE)

(21) Appl. No.: 18/328,439

(22) Filed: Jun. 2, 2023

(51) Int. Cl. G06F 9/48; G06F 9/30

(52) U.S. Cl. CPC G06F 9/4881; G06F 9/30043

(57) ABSTRACT

A computer implement method can create an entity close scheme including a plurality of nodes and edges connecting the plurality of nodes. The nodes represent task objects and the edges define predecessor-successor relationship between pairs of nodes. The method can execute the task objects and monitor status of the task objects. After flagging the status of a completed task object represented by a selected node to be invalid based on evaluation of results of the completed task object, the method can determine downstream nodes of the selected node, then identify contingent downstream nodes among the downstream nodes of the selected node, and flag the status of task objects represented by the contingent downstream nodes to be invalid upon completion of the task objects represented by the contingent downstream nodes.

### BACKGROUND

A number of advances have been made in the field of automated accounting. Huge volumes of data are now easily stored and manipulated. As part of the automated process, an entity may be required to provide a set of transactional statements along with accompanying documentation for each accounting cycle defined by a reporting key date. An “entity close” is a term describing a process that involves executing a series of interrelated and/or interdependent accounting tasks during the accounting cycle, with an ultimate goal of generating internal and external financial reports. The faster the entity close can be completed, the earlier key stakeholders can receive operational insights for making strategic organizational decisions on a timely basis. However, despite huge investments in enterprise resource planning (ERP) applications, many organizations still struggle with the automated entity close process, which can take days, weeks, or even months longer than planned to complete. Further, understanding complicated interrelationship between hundreds or even thousands of tasks can be overwhelming. Accordingly, room for improvement exists for developing advanced tools to plan, execute, monitor, and control the entire entity close cycle more efficiently.

### BRIEF DESCRIPTION OF THE DRAWINGS

FIG. 1 is an overall block diagram of an example system supporting advanced planning and execution of entity closes.

FIG. 2 is an example user interface through which a user can change properties of selected task objects.

FIG. 3 illustrates changing planned start times of task objects selected through the user interface of FIG. 2.

FIG. 4 is an example user interface through which a user can define dependencies between task objects.

FIG. 5 is an example display window which graphically depicts an example entity close scheme.

FIG. 6 is a flowchart illustrating an example overall method of implementing advanced planning and execution of entity closes.

FIG. 7A schematically depicts four predecessor nodes and three successor nodes connected by edges.

FIG. 7B schematically depicts inserting a milestone node between the four predecessor nodes and three successor nodes of FIG. 7A.

FIG. 8A schematically depicts a portion of an entity close scheme comprising a plurality of nodes and indicates the status of task objects represented by those nodes at one time point.

FIG. 8B schematically depicts the portion of the entity close scheme of FIG. 8A and indicate the status of task objects represented by the nodes at another time point.

FIG. 9A schematically depicts a portion of an entity close scheme comprising a plurality of nodes and indicate the status of task objects represented by those nodes at one time point, wherein results of one task object is flagged to be invalid.

FIG. 9B schematically depicts the portion of entity close scheme of FIG. 9A and indicate the status of task objects represented by the nodes at fourth time point, wherein results of task objects represented by some nodes are automatically flagged to be invalid.

FIG. 10A schematically depicts a portion of an entity close scheme comprising a plurality of nodes and indicate the status of task objects represented by those nodes at one time point.

FIG. 10B schematically depicts the portion of entity close scheme of FIG. 10A and indicate the status of task objects represented by the nodes at another time point.

FIG. 11 is a block diagram of an example computing system in which described embodiments can be implemented.

FIG. 12 is a block diagram of an example cloud computing environment that can be used in conjunction with the technologies described herein.

### DETAILED DESCRIPTION

### Example 1—Overview of Automated Entity Closing Process

A typical automated entity close process can involve numerous tasks (also referred to as “task objects”), which must be performed efficiently, collaboratively, and accurately before accountants can close the books on the current accounting period. The automated entity close process can have a planning phase and an execution phase. In the planning phase, the involved tasks are scheduled. In the execution phase, these tasks are executed according to the schedule. The actual execution of the tasks can be manual, semi-automatic, and/or automatic.

In planning the automated entity close, each task can be specified with a planned start time and duration, among other attributes or parameters. Additionally, dependencies between the tasks need to be defined. For example, some of the tasks must be performed sequentially. Such sequential tasks can thus form a task sequence in which the start of a successor task depends on the completion of a predecessor task. As another example, some of the tasks have to be performed in parallel, thus forming a plural of task sequences. While some of the task sequences may be independent from each other, some of the task sequences can comprise sub-sequences, thereby creating dependencies therebetween.

These tasks and their interrelationship, collectively, can be called an entity close scheme (which can also be referred to as a schedule or timetable for the entity close). In some examples, the entity close scheme can be graphically represented so as to provide a user (e.g., an accountant, etc.) a visual display of different tasks involved in the entity close and their interrelationship.

Regardless of an organization's size or financial sophistication, the automated entity close process can be extremely convoluted. For instance, a typical entity close scheme can involve hundreds or thousands of tasks organized in dozens of task sequences, and many task sequences can include two or more subsequences. Such complicated entity close scheme can be overwhelming to users, who can get frustrated by the complex task relationship.

For example, tracking the execution progress of different task can be extremely cumbersome as users can easily get lost due to the large number of tasks to be processed. As another example, sometimes the results of one completed task that were initially deemed successful may later found to be invalid. The invalidated results of such task may have cascading effects on other tasks that directly or indirectly rely on the results of such task. Tracing those negatively affected tasks and invalidate their corresponding results can be laborious, time consuming, and prone to error (e.g., fail to invalidate results of certain tasks which are negatively affected and/or erroneously invalidate results of certain tasks which are not negatively affected).

Additionally, some existing software solutions for entity close management have relatively rigid designs of entity close schemes, for example, in terms of defining the dependency between predecessor tasks and successor tasks, the planned start time of tasks, etc. Such entity close schemes lack flexibility to control timing of different tasks. As a result, potential opportunities to optimize the entity close schemes, e.g., reducing the overall duration (i.e., total execution time) of the entity close schemes, can be wasted. As described herein, optimization of an automated entity close process refers to making changes to the entity close scheme underlying the automated entity close process to reduce its overall duration. In practice, although the terms “optimal” and “optimize” are used, the shortest possible overall duration of the entity close scheme may not be achieved, but the achieved overall duration of the entity close scheme is shorter than otherwise not making those changes.

The technologies described herein provide solutions which not only allow more flexible design and optimization of entity close schemes, but also more efficient tracking the execution progress of different tasks within the entity close schemes and ensuring data validity when executing those tasks.

Although the examples described below are related to entity close, it is to be understood that the technologies disclosed herein can be used in other applications. For example, the computing system and software tools incorporating the disclosed technologies can be used for project planning/monitoring where a project schedule or scheme involves a plurality of tasks organized in a plurality of task sequences.

### Example 2—Example Advanced Entity Close Management System

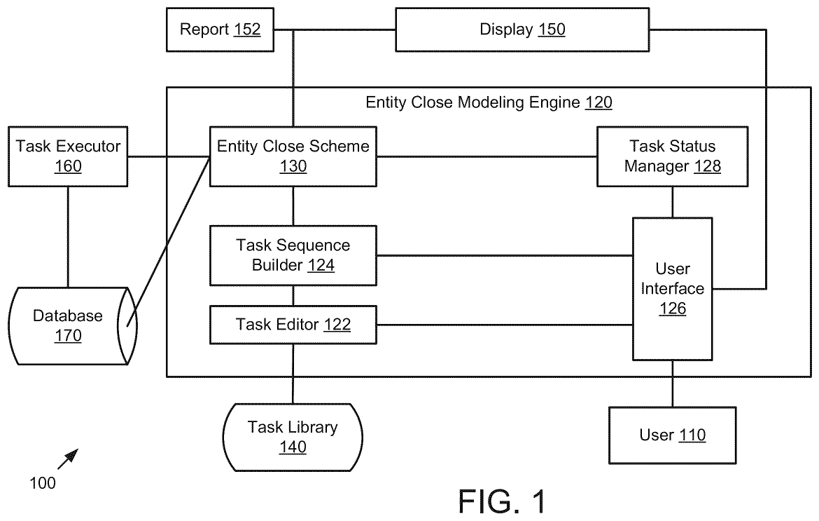

FIG. 1 is an overall block diagram of an advanced automated entity close process management system 100, according to one example.

As shown, the advanced automated entity close process management system 100 includes an entity close modeling engine 120, which can communicate with a task library 140 and a display 150. The entity close modeling engine 120 includes a task editor 122, a task sequence builder 124, a user interface 126, a task status manager 128, and at least one entity close scheme 130. At least one task executor 160 can communicate with the entity close scheme 150 and execute tasks included in the entity close scheme 130. Status of the tasks during execution can be monitored by the task status manager 128. The at least one task executor 160 can access a database 170 maintaining data pertaining to the entity close (e.g., financial transactions, taxes, resources, etc.). A user 110 can interact with the entity close modeling engine 120 through the user interface 126.

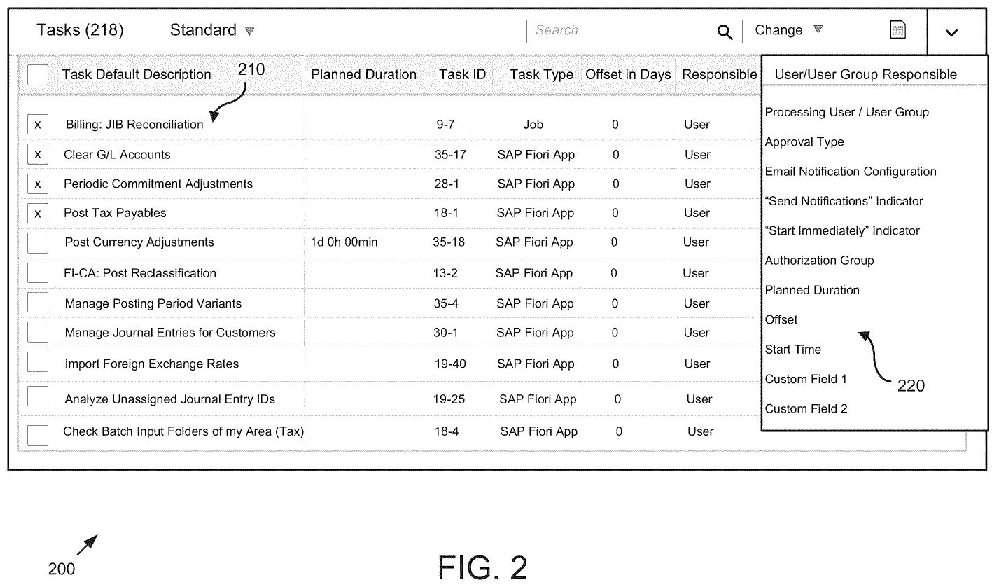

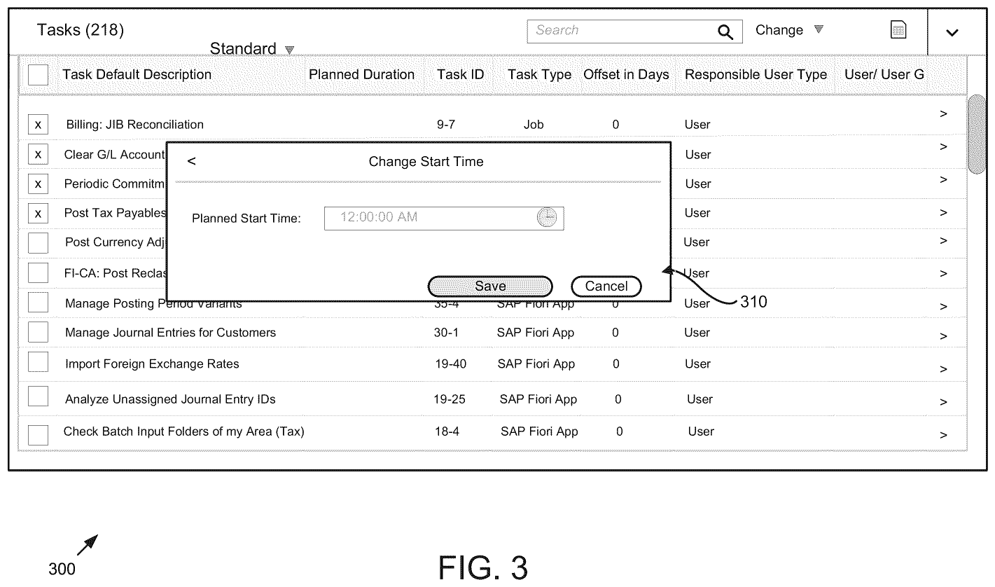

For example, the user 110 can generate reports 152 that capture snapshots of status of tasks during execution of the entity close scheme 130. As another example, the user 110 can use the task editor 122 to create and edit one or more task objects. Each task object represents a task that needs to be executed for the automated entity close process. As described further below, each task object can include a plurality of task properties, including a planned task start time, a planned duration, and other task-specific parameters, such as task identifier (ID), task status, assigned personnel responsible for the task, etc. In some circumstances, the user 110 can create new task objects based on predefined task templates stored in the task library 140. In some circumstances, the user 110 can create a new task object by first duplicating an existing task object and then editing the duplicated task object. FIG. 2 depicts an example user interface 200 (e.g., an embodiment of the user interface 126 shown on the display 150) which shows a list of task objects 210, each of which has a plurality of properties (e.g., task description, planned duration, task ID, task type, etc.) that can be defined or specified. The user 110 can select one or more of the listed task objects 210 to change their properties. For example, the user can select one or more task properties 220 associated with the selected task objects 210 for editing. In certain circumstances, the user 110 can change the planned start times and/or durations of one or more task objects. Such changes can be made, for example, if the user allocates additional resources to certain task objects, reprioritizes task objects assigned to certain personnel or user groups, and/or adjusts time gaps between task objects. To illustrate, FIG. 3 shows an example user interface 300 (e.g., an embodiment of the user interface 126 shown on the display 150) having a pop-up window 310 which allows the user 110 to change the planned start time for previously selected task objects 210.

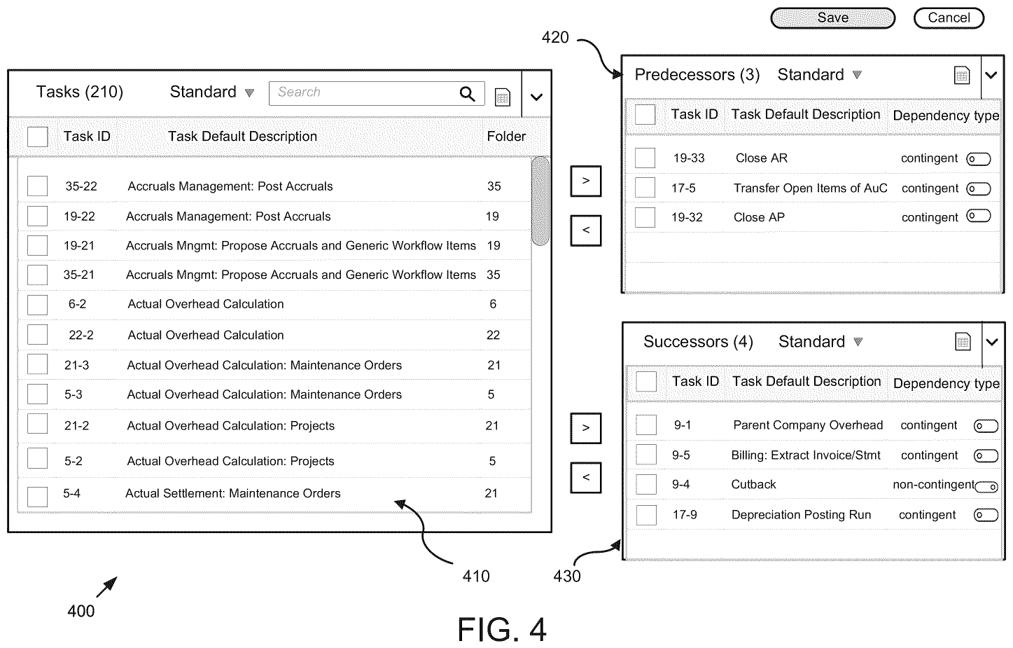

In certain examples, the user 110 can use the task sequence builder 124 to edit dependencies between task objects to build one or more task sequences. In certain examples, the dependency between task objects can be defined by a predecessor-successor relationship, where the start of a successor task object is allowed only after a predecessor task object has been completed. To illustrate, FIG. 4 shows an example user interface 400 (e.g., an embodiment of the user interface 126 shown on the display 150) which allows the user 110 to define dependencies between task objects. For example, for each task object, the user 110 can define its predecessor task objects 420 and/or successor task objects 430 by choosing from a list of available task objects 410.

In some examples, each task object can have zero, one, or more predecessor task objects. In some examples, each task object can have zero, one, or more successor task objects. While a typical task sequence may include two or more task objects having specified predecessor-successor relationship, a single task object having neither a predecessor nor a successor can also be deemed as a special case of task sequence.

In some examples, the user 110 can specify a dependency type when defining the dependency between two task objects. For example, the dependency between a predecessor task object and a successor task object can have two different dependency types: contingent and non-contingent. A contingent dependency means that the execution of the successor task object depends on the results of the predecessor task object. In contrast, a non-contingent dependency means that the execution of the successor task object does not depends on the results of the predecessor task object. For example, execution of two task objects T1 and T2 can both require certain resources. In such scenario, T2 can be configured to start only after the completion of T1 when the resources are released by T1, but the results of T1 have no impact on execution of T2 (e.g., execution of T2 can be successfully completed even if the results of T1 have errors).

In some examples, the task sequence builder 124 is configured to automatically perform a sanity check to ensure the user-specified predecessor-successor relationship is valid. For example, the task sequence builder 124 can generate warnings/errors to the use if the predecessor-successor relationship defined in a sequence includes a cycle (i.e., the execution of the task objects could otherwise lead to an endless loop).

The collection of task objects and task sequences can be referred to as an entity close scheme or schedule 130. In some examples, the created entity close scheme 130 can be stored in the database 170. In some examples, any changes to the entity close scheme 130 in the entity close modeling engine 120 can cause corresponding update of the entity close scheme 130 to be stored in the database 170. In some examples, instead of creating an entity close scheme 130 from scratch, the user 110 can retrieve from the database 170 a previously stored entity close scheme, use it as a template, and then use the task editor 122 and/or the task sequence builder 124 to edit such template to generate the desired entity close scheme.

The entity close scheme 130 can be graphically represented on the display 150 as a directed graph in which task objects can be represented as nodes and dependencies between task objects can be represented by directional edges connecting the corresponding nodes. Thus, the predecessor-successor relationship between two task objects can be graphically represented by a directional edge connecting two nodes representing the two task objects (e.g., a predecessor task object can be represented by a predecessor node and a successor task object can be represented by a successor node).

In some examples, the entity close scheme 130 can be associated with a closing target time, which can be automatically determined based on the task objects included in the entity close scheme 130 or defined by the user 110 (e.g., via the user interface 126). The closing target time represents a deadline by which time the automated entity close process represented by the entity close scheme 130 must be completed.

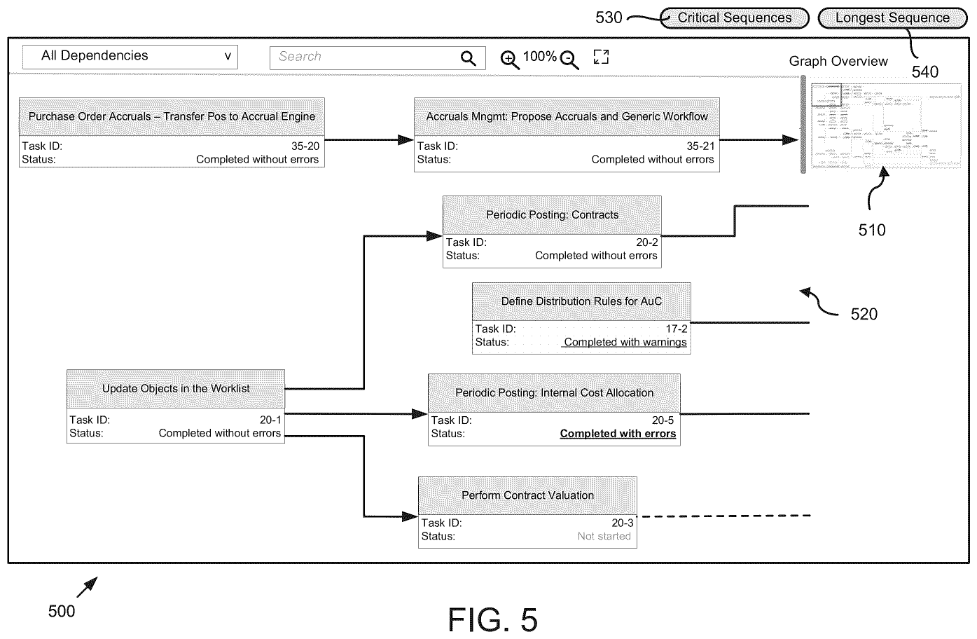

As an example, FIG. 5 depicts a graphical user interface 500 (e.g., an embodiment of the user interface 126 shown on the display 150) which shows an example entity close scheme 510 (e.g., an embodiment of the entity close scheme 130). As the whole entity close scheme 510 can include hundreds or thousands of task objects and/or task sequences, the user can choose to view only a selected portion 520 of the entity close scheme 510, e.g., by zooming and/or panning the entity close scheme 510. As illustrated in FIG. 5, each task object can be represented by a rectangular (or other shaped) node, on which selected property information (e.g., object description, task ID, task status, etc.) can be displayed.

The dependencies between task objects can be represented by directed edges or arrows. In some circumstances, different dependency types can be depicted differently. For example, a contingent dependency can be represented by a solid line (e.g., the edge between node “Update Objects in the Worklist” and node “Perform Contract Valuation,” etc.), and a non-contingent dependency can be represented by a dashed line (e.g., the edge connecting the node “Perform Contract Valuation” to its successor node, etc.). Other ways to differentiate between contingent dependency and non-contingent dependency (e.g., by different colors, line widths, etc.) can also be used.

As described herein, the task status of a task object reflects the execution status of the task object. For example, the execution status of a task object can be “not started,” “in progress,” “completed without errors,” “completed with warnings,” “completed with errors,” etc. In certain examples, the displayed task objects can be color coded (or through other visually distinguishable features such as shade/fill patterns, border types, displayed fonts, or the like) to provide visual indications of their corresponding task status.

In some examples, a validity flag can be added to the status of a completed task object to indicate whether results of the task object are valid or not. For example, a completed task object can have an initial status of “completed without errors.” After finding the results of the completed task object are inaccurate or not reliable (e.g., through a review process which can be performed manually or automatically by another software application), the status of the task object can be changed to “completed with errors.” In such scenarios, as described below, the results of some downstream task objects can be automatically flagged to be invalid. Conversely, after changing the status of the completed task object from “completed with errors” to “completed without errors” (e.g., through a review process), in certain circumstances (e.g., if the task object has not been re-executed), the invalidity flag previously added to those downstream task objects can be automatically cleared.

During the automated entity close process, task objects in the entity close scheme 510 are executed. Execution of the task objects can be performed by one or more task executors 160. Some task executors 160 can be software applications configured to execute certain task objects automatically (e.g., calculating asset depreciations, converting currencies based on foreign exchange rate, generating financial reports, etc.). Some task executors 160 can involve manual operations. Execution of the task objects by the task executors 160 can involve accessing data stored in the database 170. For example, at the start of a task object, the task executor 160 can retrieve relevant financial data resource information stored in the database 170. As another example, upon the completion of a task object, data relevant to the task object can be updated in the database 170 (e.g., updating relevant financial records, releasing resources assigned to the task object, etc.).

The task status of each task object can be monitored, for example, by the task status manager 128. In some examples, the task status of a task object can be automatically changed by a running software (e.g., an application run by the task executor 160, etc.) in communication with the task status manager 128. In some examples, the user 110 can manually change the task status of a selected task object through the graphical user interface 500 (e.g., by double clicking the selected task object to open an editor to change the task status of the selected task object, or the like). In some examples, a validity flag can be added to or removed from the task status of a completed task object. In some examples, the task status of each task object can be stored and updated in the database 170.

In some examples, some of the task sequences can be determined to be target critical sequences. A task sequence can be deemed to be a target critical sequence if the planned completion time of the last task object in that task sequence is sufficiently close to the closing target time. Additionally, at least one of the task sequences can be determined to be longest sequence. In some examples, the user 110 can select displaying only target critical sequences (e.g., by clicking a “Critical Sequences” button 530) and/or the longest sequence (e.g., by clicking a “Longest Sequence” button 540). In some examples, task objects included in the target critical sequences and longest sequence can be highlighted using visually distinctive features (e.g., colors, shade/fill patterns, border types, displayed fonts, or the like).

Returning to FIG. 1, the user 110 can perform enhanced entity close modeling by interacting with the entity close modeling engine 120. For example, through the user interface 126, the user 110 can change the dependency types between different task objects (e.g., from contingent to non-contingent, or vice versa). The user 110 can also change the planned start times of certain tasks and/or define triggers for starting certain tasks, as described below. Additionally, the user 110 can monitor results of completed task objects, based on which to add and/or remove validity flags, thereby controlling the process flow of entity close. As described further below, in some circumstances, the user 110 can create milestones node(s) in an entity close scheme to simplify the edges or dependencies between groups of nodes or task objects.

Additionally, the user 110 can explore opportunities to optimize the automated entity close process by simulating changes to the entity close scheme 130, e.g., by changing planned start times and/or durations of certain tasks, and/or by changing the closing target time associated with the entity close scheme 130. Responsive to the simulated changes to the entity close scheme 130, the target critical sequences and the longest sequence can be updated on the display 150. If the user 110 is satisfied with the simulated results, the user 110 can accept the simulated changes, thereby updating the entity close scheme 130.

Additionally, during execution of the entity close scheme 130, changes in the task status of certain task objects (e.g., detected by the task status manager 128) may prompt the user 110 to adjust the entity close scheme 130 (e.g., via the user interface 126) on the fly, for example, by changing the planned start times and/or durations of certain task objects, and/or changing the closing target time associated with the entity close scheme 130. Likewise, adjustment to the entity close scheme 130 can cause update of the target critical sequences and the longest sequence on the display 150.

In practice, the systems shown herein, such as the system 100, can vary in complexity, with additional functionality, more complex components, and the like. For example, there can be additional functionality within the entity close modeling engine 120. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the tasks, task sequences, dependency types, or the like can be stored in one or more computer-readable storage media or computer-readable storage devices. The technologies described herein can be generic to the specifics of operating systems or hardware and can be applied in any variety of environments to take advantage of the described features.

### Example 3—Example Overall Method for Enhanced Entity Close Modeling

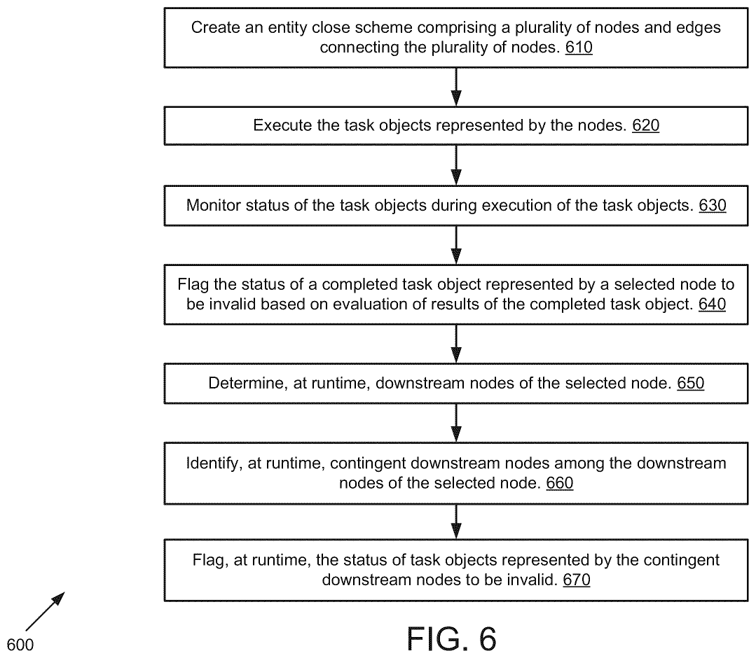

FIG. 6 is a flowchart of an example overall method 600 for enhanced entity close modeling, and can be implemented, for example, by the advanced automated entity close process management system of FIG. 1.

At 610, an entity close scheme (e.g., 130) can be created. As described above, the entity close scheme can include a plurality of nodes and edges connecting the plurality of nodes. The nodes represent task objects with predefined timing conditions, and the edges define predecessor-successor relationship between pairs of nodes. In some examples, the entity close scheme can be generated by the user through the entity close modeling engine 120. In some examples, the entity close modeling engine 120 can receive a copy of the entity close scheme from another source.

At 620, the task objects represented by the nodes can be executed, e.g., by the task executor 160, according to the predefined timing conditions of the task objects and the predecessor-successor relationship defined by the edges.

At 630, status of the task objects during execution of the task objects can be monitored, e.g., by the task status manager 128.

At 640, the status of a completed task object represented by a selected node can be flagged to be invalid based on evaluation of results of the completed task object. In some examples, the results of the task object can be flagged to be invalid after a review process, which can be performed manually (e.g., by the user 110 through the user interface 126) or automatically by another software application. For example, after a review process, the status of a completed task object can be changed from “completed without errors” to “completed with errors” to indicate that the results of the completed task object are invalid.

At 650, downstream nodes of the selected node can be determined at runtime. As described herein, a downstream node is directly or indirectly connected to the selected node by one or more edges. In any of the examples described herein, an operation performed in runtime means that the operation can be completed in real time or with minimal processing delay (e.g., the operation can be completed within 1 second, or more desirably, less than 100 millisecond).

At 660, contingent downstream nodes among the downstream nodes of the selected node can be identified at runtime. The edges connecting a contingent downstream node to the selected node have a contingent property (also referred to as “contingent dependency”). In other words, in a chain starting from the selected node to a contingent downstream node, each pair of directly connected nodes have a contingent dependency. As described herein, the contingent property of an edge connecting a predecessor node to a successor node indicates that results of a task object represented by the successor node is contingent on results of a task object represented by the predecessor node.

At 670, the status of task objects represented by the contingent downstream nodes can be automatically flagged, at runtime, to be invalid upon completion of the task objects represented by the contingent downstream nodes. In some examples, the steps 650, 660, and 670 can be performed by the task status manager 128.

The method 600 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “receive” can also be described as “send” from a different perspective.

### Example 4—Example Milestone Nodes

In some examples, a user can create milestone nodes in an entity close scheme. As described herein, a milestone node represents a pseudo task object having zero execution duration. Like other nodes, the pseudo task object represented by a milestone stone can have a plurality of properties, such as task ID, task status, assigned responsible personnel, etc. However, because the pseudo task object is not actually executed by the task executor 160, its execution duration can be set to zero.

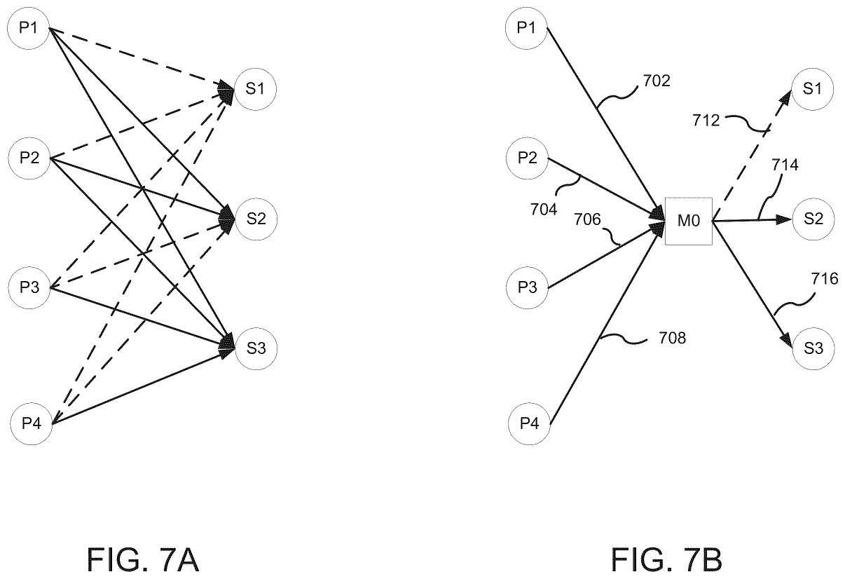

The milestone nodes can be used to simplify predecessor-successor relationship between groups of nodes, as illustrated in FIGS. 7A-7B. FIG. 7A schematically depicts four predecessor nodes (P1, P2, P3, and P4) and three successor nodes (S1, S2, and S3) connected by edges. In any of the examples described hereinafter, edges with contingent dependencies are shown in solid lines and edges with non-contingent dependencies are shown in dashed lines. In the depicted example, there are a total of twelve edges connecting each of the four predecessor nodes to each of the three successor nodes. Six of the edges have contingent dependencies and the other six edges have non-contingent dependencies.

FIG. 7B schematically depicts inserting a milestone node MO between the four predecessor nodes and three successor nodes. Instead of directly connecting the predecessor nodes to the successor nodes, the milestone node MO serves as an intermediary therebetween. In other words, the milestone node MO becomes the single successor node of the four predecessor nodes (P1, P2, P3, and P4), as well as the single predecessor node of the three successor nodes (S1, S2, and S3).

For example, each of the predecessor nodes (P1, P2, P3, and P4) can be connected to the milestone node MO by a corresponding edge (e.g., 702, 704, 706, and 708), and the milestone node MO is further connected to each of the successor nodes (S1, S2, and S3) by a corresponding edge (e.g., 712, 714, and 716). Thus, by inserting the milestone node MO, the total number of edges between the four predecessor nodes (P1, P2, P3, and P4) and three successor nodes (S1, S2, and S3) is reduced from twelve to seven.

More generally, if P predecessor nodes and S successor nodes that are interconnected by P×S edges therebetween (P>1 and S>1), a milestone node can be inserted between the P predecessor nodes and S successor nodes by (a) removing the P×S edges connecting the P predecessor nodes and S successor nodes; (b) creating P new edges connecting the P predecessor nodes to the milestone node; and (c) creating S new edges connecting the milestone node to the S successor nodes. As a result, the total number of edges between the P predecessor nodes and S successor nodes is reduced from P×S to P+S. Reducing the number of edges in a large entity scheme can significantly reduce the complexity of internodal relationship.

In some examples, dependency types of the new edges connecting the milestone nodes to predecessor nodes and successor nodes can be determined, using predefined rules, based on original edges which directly connect the predecessor nodes to the successor nodes.

According to one example rule, if any of the edges which directly connects one predecessor node (e.g., P1) to its successor nodes (e.g., edges between P1-S1, P1-S2, and P1-S3) has a contingent dependency, then after inserting the milestone node (e.g., MO), the new edge connecting the predecessor node to the milestone node (e.g., the edge 702 connecting P1 and MO) also has a contingent dependency. On the other hand, if all edges which directly connects one predecessor node to its successor nodes have a non-contingent dependency (e.g., assuming changing the edges between P1-S2 and P1-S3 in FIG. 7A to non-contingent dependency), then after inserting the milestone node, the new edge connecting the predecessor node to the milestone node (e.g., the edge 702) would also have a non-contingent dependency.

According to another example rule, if any of the edges which directly connects one successor node (e.g., S2) to its predecessor nodes (e.g., edges between P1-S2, P2-S2, P3-S2, and P4-S2) has a contingent dependency, then after inserting the milestone node (e.g., MO), the new edge connecting the milestone node to the successor node (e.g., the edge 714 connecting MO and S2) also has a contingent dependency. On the other hand, if all edges which directly connects one successor node (e.g., S1) to its predecessor nodes have a non-contingent dependency (e.g., the edges between P1-S1, P2-S1, P3-S1, and P4-S1 shown in FIG. 7A), then after inserting the milestone node, the new edge connecting the milestone node to the successor node (e.g., the edge 712 connecting MO and S1 as shown in FIG. 7B) also has a non-contingent dependency.

The insertion of milestone nodes in an entity close scheme not only can simplify the interrelationship between predecessor and successor nodes (e.g., reducing the number of edges), but also can signify watch points or milestones for tracking the overall progress of the entire entity close process and adjusting the entity close scheme based on such evaluation, if needed. For instance, the user 110 can generate reports 152 at the successful completion of the pseudo task object represented by a milestone object, and adjust the entity close scheme accordingly based on such reports.

Moreover, the insertion of milestone nodes in an entity close scheme can simplify inserting new nodes into and/or removing existing nodes from the entity close scheme. For example, when the entity close scheme depicted in FIG. 7B is later updated by adding a new predecessor node to the nodes S1-S3, instead of creating three edges connecting the new predecessor node to the nodes S1-S3, respectively, only one edge needs to be created to connect the new predecessor node to the milestone node MO. As another example, when the entity close scheme is later updated by adding a new successor node to the nodes P1-P4, instead of creating four edges connecting the nodes P1-P4 to the new successor node, respectively, only one edge needs to be created to connect the milestone node MO to the new successor node. Conversely, if any one of the predecessor nodes P1-P4 and/or successor nodes S1-S3 needs to be removed from the entity close scheme, only the edge connecting that node and the milestone node MO needs to be removed. Thus, the milestone nodes can improve efficiency of lifecycle management of the entity close scheme.

### Example 5—Example Method of Changing Status of Pseudo Task Objects

As described herein, the status of a pseudo task object represented by a milestone node can be determined by the status of all task objects that are predecessors of the pseudo task object. For example, in FIG. 7B, the status of the pseudo task object represented by the milestone node M can be determined by the status of all task objects represented by the four predecessor nodes (P1, P2, P3, and P4).

Generally, assume a milestone node has P predecessor nodes. Further assume the milestone node is connected to its predecessor nodes by edges with a contingent dependency. If the task objects represented by the P predecessor nodes have all been successfully completed (e.g., with status “completed without errors”) at respective completion times, the latest one of the completion times of the task objects represented by the P predecessor nodes can be determined as a “last completion time.” Then, the status of the pseudo task object represented by the milestone node can be changed to indicate a successful completion of the pseudo task object (e.g., status is changed to “completed without errors”) at the last completion time. In other words, the pseudo task object is deemed to be successfully completed if, and only if, all predecessor task objects of the pseudo task object are successfully completed. On the other hand, if the milestone node is connected to predecessor nodes by edges with a non-contingent dependency, then the completion times of task objects represented by those predecessor nodes can be used to determine the last completion time, regardless of whether those task objects are completed successfully or not.

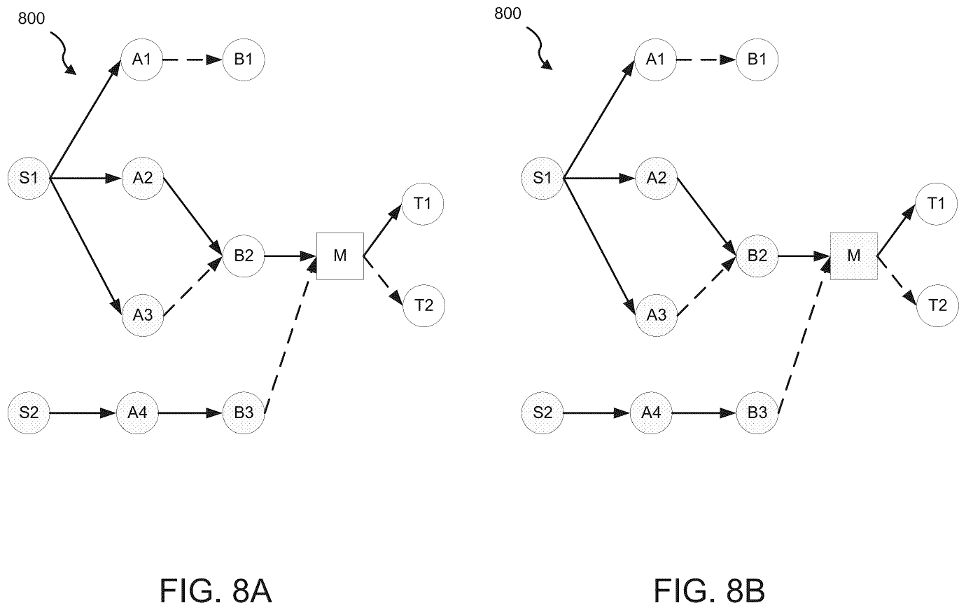

Another example is shown in FIGS. 8A-8B, which schematically depict a portion of an entity close scheme 800. As shown, the entity close scheme 800 includes a plurality of nodes (e.g., nodes S1-S2, A1-A4, B1-B3, T1-T2, and a milestone node M) that are interconnected by edges. Some of the edges have contingent dependencies (shown in solid lines) and some of the edges have non-contingent dependencies (shown in dashed lines). In the depicted example, shading of the nodes is used to indicate status of the task objects represented by the nodes. For example, nodes with a white background indicate the task objects represented by those nodes have a “not started” status, and nodes with a dotted background indicate the task objects represented by those nodes have a “completed without errors” status.

FIG. 8A shows the entity close scheme 800 at one time point, when task objects represented by nodes S1, S2, A2, A3, A4, and B3 have all been successfully completed, while task objects represented by nodes A1, B1, B2, M, T1, and T2 have not started. FIG. 8B shows the entity close scheme 800 at a later time point when the task object represented by the node B2 has just been successfully completed. Because the milestone nodes M has two predecessor nodes B2 and B3, and the task objects represented by both nodes have been successfully completed, the pseudo task object represented by the milestone node M is also automatically updated to indicate its successful completion (at the same time when the task object represented by the node B2 was successfully completed).

### Example 6—Example Method of Invalidating Results of Task Objects

As described above, a completed task object represented by a selected node can have an initial status of “completed without errors,” but later flagged to have invalid results after a review process (e.g., the status of the task object can be changed to “completed with errors”). In such circumstances, contingent downstream nodes of the selected node can be automatically identified, and status of task objects represented by these contingent downstream nodes are also automatically flagged to be invalid upon task completion.

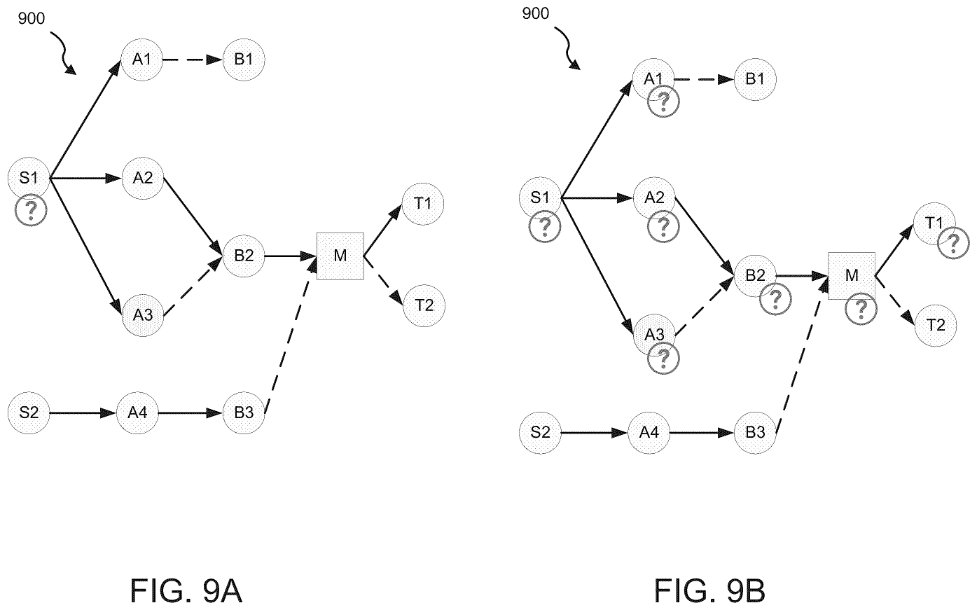

As an example, FIGS. 9A-9B show a portion of an entity close scheme 900 that is similar to the entity close scheme 800 depicted in FIGS. 8A-8B. FIG. 9A shows the entity close scheme 900 at one time point, when task objects represented by nodes S1-S2, A1-A4, B1-B3, M, and T1-T2 have all been successfully completed. In this example, a question mark is attached to the node S1, indicating that results of the task object represented by the node S1 is flagged to be invalid (e.g., changing its status to “completed with errors”).

Upon flagging the results of task object represented by node S1 to be invalid, all downstream nodes of S1 can be identified (e.g., step 650 in FIG. 6). In this example, nodes A1-A3, B1-B2, M, and T1-T2 are deemed to be downstream nodes of S1 as it is possible to traverse from the node S1 to each of these nodes by one or more directional edges. Then, among these identified downstream nodes, all contingent downstream nodes of S1 can be automatically determined (e.g., step 660 in FIG. 6). The contingent downstream nodes of S1 can be determined all at once or through a cascading approach along edges with contingent dependencies. In this example, nodes A1, A2, A3, B2, M, and T1 are deemed to be contingent downstream nodes of S1 because each of these nodes is directly or indirectly connected to the node S1 by edges having the contingent dependency. Thus, as shown in FIG. 9B, the status of task objects represented by these contingent downstream nodes can be automatically flagged to be invalid upon completion of these task objects (e.g., step 670 in FIG. 6).

In some examples, for each task object whose status is flagged to be invalid, the node representing the task object can have a source field which specifies which predecessor node(s) are responsible for the flagged invalid status. For example, in FIG. 9B, the source fields in nodes A1, A2 and A3 can indicate that node S1 is solely responsible for the invalid status in nodes A1, A2, and A3, respectively, whereas the responsible field in node B2 can indicate that both nodes A2 and A3 are responsible for the invalid status in node B2. Thus, for each node associated with an invalid status, the source task object(s) that ultimately cause the invalid status can be traced backwardly.

In contrast, nodes B1 and T2 are deemed to be non-contingent downstream nodes of S1. As described herein, a non-contingent downstream node is identified if it is connected to all its predecessor nodes by edges with a non-contingent property, and those predecessor nodes are either the selected node or downstream nodes of the selected node. For example, node B1 is connected to the node A1 by an edge with a non-contingent dependency, and node T2 is connected to the milestone node M by an edge with a non-contingent dependency. As a result, invalidating the results of task object represented by node S1 does not change the status of task objects represented by the non-contingent downstream nodes B1 and T2.

Note that in this example, node B2 is a contingent downstream node of S1. Even though node B2 is connected to one of its predecessor nodes A3 by an edge with a non-contingent dependency, node B2 is connected to another one of its predecessor nodes A2 by an edge with a contingent dependency. If, on the other hand, the edge connecting the nodes A2 and B2 also has a non-contingent dependency, then node B2, as well as nodes M and T1, will become non-contingent downstream nodes of S1.

After removing the invalidity flag for the task object represented by node S1, if the task object represented by node S1 has not been re-executed, the invalidity flag added to the task objects represented by the contingent downstream nodes A1, A2, A3, B2, M, and T1 can also be automatically removed. However, if the task object represented by the node S1 has already been re-executed, then automatic removal of the invalid status of its contingent downstream nodes is prohibited because the results of task objects represented by those contingent downstream nodes are still based on the invalid results of task object represented by the node S1 (before its re-execution). In other words, removing the invalid status of the task objects represented by contingent downstream nodes of a selected node is contingent on a condition that the results of the completed task object represented by the selected node have not been changed since flagging the status of the completed task object represented by the selected node to be invalid.

Further, removing the invalid status of a task object represented by a contingent downstream node of a selected node can be contingent on another condition that the selected node is the only ultimate source that causes the invalid status of the task object. For example, in FIG. 9B, if the invalid status associated with node A1 is caused not only by the invalid status associated with node S1, but also by the invalid status associated with another independent predecessor node (not shown) of A1 (with a contingent edge therebetween), then removing the invalid status associated with node S1 alone would not be sufficient to remove the invalid status associated with the node A1 unless the invalid status associated with the other independent predecessor node of A1 is also removed (and the corresponding task object has not been re-executed). As described above, identifying the ultimate source(s) that cause the invalid status associated with a node can be performed by backward tracing based on the source fields of the nodes.

### Example 7—Example Enabling/Disabling Conditions for Executing Task Objects Based on Dependency Types

Some existing software solutions for entity close management have relatively rigid designs of entity close schemes. For example, existing entity close management software only supports one particular dependency type between predecessor nodes and successor nodes. As a result, edges between predecessor nodes and successor nodes in an entity close scheme either all have the contingent dependency, or all have the non-contingent dependency, but not both. The technologies described herein allows edges in an entity close scheme to have both contingent and non-contingent dependency types. The co-existence of both dependency types in one entity close scheme can allow more flexible control on timing conditions of task objects included in the entity close scheme.

As described above, if an edge between a predecessor node and a successor node has a contingent dependency, the execution of a task object represented by the successor node depends on the results of a task object represented by the predecessor node. Thus, in such circumstances, the task object represented by the successor node cannot start unless the task object represented by the predecessor node has successfully completed. For example, if the status of the task object represented by the predecessor node has the status “completed with errors” (and/or with the status “completed with warnings”), then execution of the task object represented by the successor node is disabled.

In contrast, if an edge between a predecessor node and a successor node has a non-contingent dependency, the execution of a task object represented by the successor node does not depend on the results of a task object represented by the predecessor node. Thus, in such circumstances, execution of the task object represented by the successor node can proceed if the task object represented by the predecessor node has completed (thus releasing its resources), even if the results of the task object represented by the predecessor node have errors.

If a successor node has multiple predecessor nodes, and if one of the predecessor nodes is connected to the successor node by an edge with a contingent dependency, then execution of the task object represented by the successor node will be disabled if the results of that predecessor node have errors.

On the other hand, if a successor node has multiple predecessor nodes, and if all those predecessor nodes are connected to the successor node by edges with a non-contingent dependency, then execution of the task object represented by the successor node is enabled so long as all task objects represented by the predecessor nodes are completed, regardless of having error conditions or not.

In the examples depicted in FIGS. 8A-8B, the node B2 has two predecessor nodes A2 and A3. The edge between A2 and B2 has a contingent dependency and the edge between A3 and B2 has a non-contingent dependency. Thus, if the task object represented by A2 has completed with errors, execution of the task object represented by B2 will be disabled. However, if the task object represented by A2 has been successfully completed, execution of the task object represented by B2 can start so long as the task object represented by A3 has also completed, even if the status of the task object represented by A3 indicates an error condition.

### Example 8—Example Start Times of Task Objects

According to the technologies described herein, timing of the task objects in an entity close scheme can also be flexibly controlled by specifying task properties of the task objects, such as planned start time and/or start trigger.

For example, when creating an entity close scheme, a user can define a planned start time for a task object represented by a selected node. Execution of the task object will start at the planned start time on a condition that all its predecessor task objects (represented by respective predecessor nodes of the selected node) have been completed at respective completion times before the planned start time. Further, if a predecessor task object and the task object have a contingent dependency relationship, the completion of the predecessor task object must be successful in order to enable the task object to start at the planned start time.

As another example, when creating an entity close scheme, a user can define a start trigger (or simply “trigger”) for a task object represented by a selected node. Such trigger can cause the execution of the task object to start at a last completion time on a condition that all its predecessor task objects (represented by respective predecessor nodes of the selected node) have been completed at respective completion times, wherein the last completion time is the latest one of the completion times of all predecessor task objects. Likewise, if a predecessor task object and the task object have a contingent dependency relationship, the completion of the predecessor task object must be successful in order to enable the task object to start at the last completion time.

In some examples, the user can specify both a planned start time and the trigger for the task object. This can be helpful for planning and optimization purposes (e.g., the user-specified planned start time can be used to identify whether a task object is overdue and/or identify opportunities for reduction of overall execution time of the entity close scheme). In such circumstances, the trigger can cause the execution of the task object to start before the planned start time (e.g., if the last completion time is before the planned start time). Thus, by executing the task object immediately instead of waiting for the planned start time, the trigger can eliminate the time gap or idle time between the last completion time and the planned start time, thereby potentially can reduce the overall duration of the entity close scheme.

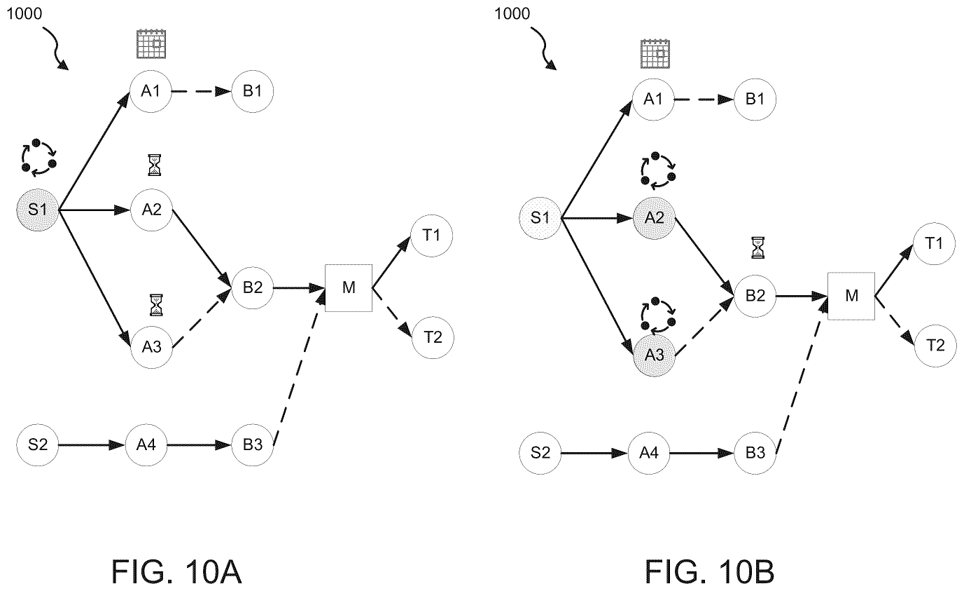

As an example, FIGS. 10A-10B show a portion of an entity close scheme 1000 that is similar to the entity close scheme 800 depicted in FIGS. 8A-8B. FIG. 10A shows the entity close scheme 1000 at one time point, when the task object represented by node S1 is being executed (indicated by the greyed background of the node and a roundabout icon) while task objects represented by other nodes have not started. In this example, the task object represented by node A1 has a planned start time without a trigger (as indicated by a calendar icon), whereas the task objects represented by nodes A2 and A2 have specified triggers (as indicated by the hourglass icons). FIG. 10B shows the entity close scheme 1000 at a later time point when the task object represented by node S1 has been successfully completed but before the planned start time of task object represented by node A1. Thus, the task object represented by node A1 cannot get started. However, the task objects represented by nodes A2 and A3 are being executed because their starts were triggered by the successful completion of the task object represented by node S1.

### Example 9—Example Advantages

A number of advantages can be achieved via the technologies described herein.

As described above, an entity close scheme can be extremely convoluted such that a user can easily get overwhelmed by the large number of nodes and interconnecting edges. By inserting milestone nodes into the entity close scheme, the number of edges can be reduced, thereby simplifying complex internodal relationship. Moreover, the milestone nodes can signify watch points for evaluating the overall progress of the entire entity close process and make it easier for the user to dynamically adjust the entity close scheme based on such evaluation, if needed. Further, the milestone nodes allow easier update of the entity close scheme overtime (e.g., insert new nodes into and/or remove existing nodes from the entity close scheme), thus improving lifecycle management of entity close process.

As described above, existing entity close management solutions have more rigid designs of entity close schemes in terms of defining the dependency between predecessor task objects and successor task objects, the planned start time of task objects, etc. As a result, potential opportunities to optimize the entity close schemes, e.g., reducing the overall duration of the entity close schemes, can be wasted.

For example, some existing entity close management solutions only allow a user to define planned start time of different task objects. As a result, resources may stay idle before the planned start time of a successor task object even if all its predecessor task objects have successfully completed. The technologies described herein allow the user to define start triggers in addition to the planned start time. The start triggers can eliminate such idle time, thereby potentially reducing the overall duration of the entity close scheme.

As another example, some existing entity close management solutions only support edges with contingent dependencies. Thus, even if a successor task object does not depend on results of a predecessor task object, the successor task object still cannot get started unless the predecessor task object has completed successfully. The technologies described herein allows the co-existence of edges with both contingent and non-contingent dependency types in an entity close scheme, thus offering more flexible control on timing conditions of task objects included in the entity close scheme. For example, a successor task object that does not depend on results of a predecessor task object can start right after the completion of the predecessor task object (but not running in parallel, e.g., due to resource constraints), even if the results of the predecessor task object have errors.

Further, is not uncommon that the results of a successfully completed task object were later found to be invalid. When this happens, existing entity close management solutions which only support contingent dependencies may prompt a user to manually flag the results of all downstream task objects to be invalid (and cause them to be re-executed), even if some of the downstream task objects do not depend on the invalid results of the task object. According to the technologies described herein, the co-existence of both contingent and non-contingent dependency types in an entity close scheme allows differential treatment of invalid results. For example, when the results of a successfully completed task object is later flagged to be invalid, the results of all task objects that are represented by contingent downstream nodes can be automatically invalidated in runtime, whereas the results of task objects that are represented by non-contingent downstream nodes can still stay valid. As a result, only those impacted task objects need to be re-executed, thereby reducing potential waste of resources and improving the operating efficiency compared to existing entity close management solutions.

### Example 10—Example Computing Systems

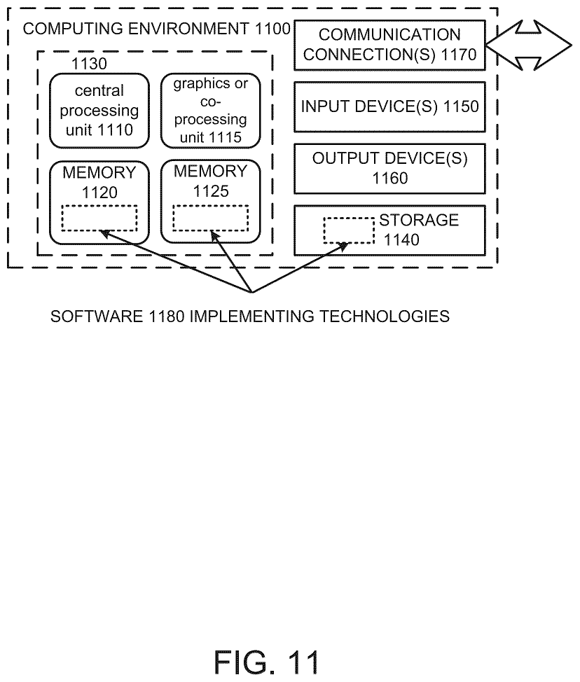

FIG. 11 depicts an example of a suitable computing system 1100 in which the described innovations can be implemented. The computing system 1100 is not intended to suggest any limitation as to scope of use or functionality of the present disclosure, as the innovations can be implemented in diverse computing systems.

With reference to FIG. 11, the computing system 1100 includes one or more processing units 1110, 1115 and memory 1120, 1125. In FIG. 11, this basic configuration 1130 is included within a dashed line. The processing units 1110, 1115 can execute computer-executable instructions, such as for implementing the features described in the examples herein (e.g., the method 600, etc.). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 11 shows a central processing unit 1110 as well as a graphics processing unit or co-processing unit 1115. The tangible memory 1120, 1125 can be volatile memory (e.g., registers, cache, RAM), non-volatile memory (e.g., ROM, EEPROM, flash memory, etc.), or some combination of the two, accessible by the processing unit(s) 1110, 1115. The memory 1120, 1125 can store software 1180 implementing one or more innovations described herein, in the form of computer-executable instructions suitable for execution by the processing unit(s) 1110, 1115.

A computing system 1100 can have additional features. For example, the computing system 1100 can include storage 1140, one or more input devices 1150, one or more output devices 1160, and one or more communication connections 1170, including input devices, output devices, and communication connections for interacting with a user. An interconnection mechanism (not shown) such as a bus, controller, or network can interconnect the components of the computing system 1100. Typically, operating system software (not shown) can provide an operating environment for other software executing in the computing system 1100, and coordinate activities of the components of the computing system 1100.

The tangible storage 1140 can be removable or non-removable, and includes magnetic disks, magnetic tapes or cassettes, CD-ROMs, DVDs, or any other medium which can be used to store information in a non-transitory way and which can be accessed within the computing system 1100. The storage 1140 can store instructions for the software 1180 implementing one or more innovations described herein.

The input device(s) 1150 can be an input device such as a keyboard, mouse, pen, or trackball, a voice input device, a scanning device, touch device (e.g., touchpad, display, or the like) or another device that provides input to the computing system 1100. The output device(s) 1160 can be a display, printer, speaker, CD-writer, or another device that provides output from the computing system 1100.

The communication connection(s) 1170 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer, and should not be confused with acts performed by a human being. The actual computer operations corresponding to these terms vary depending on implementation.

### Example 11—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example 12—Example Cloud Computing Environment

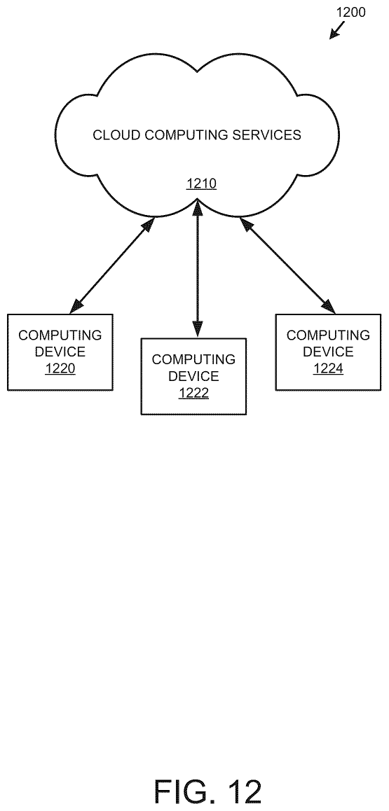

FIG. 12 depicts an example cloud computing environment 1200 in which the described technologies can be implemented, including, e.g., the system 600 and other systems herein. The cloud computing environment 1200 can include cloud computing services 1210. The cloud computing services 1210 can comprise various types of cloud computing resources, such as computer servers, data storage repositories, networking resources, etc. The cloud computing services 1210 can be centrally located (e.g., provided by a data center of a business or organization) or distributed (e.g., provided by various computing resources located at different locations, such as different data centers and/or located in different cities or countries).

The cloud computing services 1210 can be utilized by various types of computing devices (e.g., client computing devices), such as computing devices 1220, 1222, and 1224. For example, the computing devices (e.g., 1220, 1222, and 1224) can be computers (e.g., desktop or laptop computers), mobile devices (e.g., tablet computers or smart phones), or other types of computing devices. For example, the computing devices (e.g., 1220, 1222, and 1224) can utilize the cloud computing services 1210 to perform computing operations (e.g., data processing, data storage, and the like).

In practice, cloud-based, on-premises-based, or hybrid scenarios can be supported.

### Example 13—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

### Example 14—Example Embodiments

Any of the following example embodiments can be implemented.

Example 1. A computer-implemented method for improved entity close management, the method comprising: creating an entity close scheme comprising a plurality of nodes and edges connecting the plurality of nodes, wherein the nodes represent task objects with predefined timing conditions, and the edges define predecessor-successor relationship between pairs of nodes; executing the task objects represented by the nodes according to the predefined timing conditions of the task objects and the predecessor-successor relationship defined by the edges; monitoring status of the task objects during execution of the task objects; flagging the status of a completed task object represented by a selected node to be invalid based on evaluation of results of the completed task object; determining, at runtime, downstream nodes of the selected node, wherein a downstream node is connected to the selected node by one or more edges; identifying, at runtime, contingent downstream nodes among the downstream nodes of the selected node, wherein the edges connecting a contingent downstream node to the selected node have a contingent property, wherein the contingent property of an edge connecting a predecessor node to a successor node indicates that results of a task object represented by the successor node is contingent on results of a task object represented by the predecessor node; and flagging, at runtime, the status of task objects represented by the contingent downstream nodes to be invalid upon completion of the task objects represented by the contingent downstream nodes.

Example 2. The method of example 1, further comprising identifying, at runtime, non-contingent downstream nodes among the downstream nodes of the selected node, wherein a non-contingent downstream node is connected to one or more predecessor nodes that are either the selected node or downstream nodes of the selected node by edges with a non-contingent property, wherein the non-contingent property of an edge connecting a predecessor node to a successor node indicates that results of a task object represented by the successor node is not contingent on results of a task object represented by the predecessor node, wherein flagging the status of the completed task object represented by the selected node does not change the status of task objects represented by the non-contingent downstream nodes.

Example 3. The method of example 2, wherein execution of a task object represented by a successor node is disabled responsive to finding that the successor node is connected to at least one predecessor node by an edge having the contingent property, and status of a task object represented by the predecessor node indicates that the task object represented by the predecessor nodes is completed with an error.

Example 4. The method of any one of examples 2-3, wherein execution of a task object represented by a successor node is enabled responsive to finding that the successor node is solely connected to one or more predecessor nodes by edges having the non-contingent property, wherein status of the task objects represented by the one or more predecessor nodes indicate that the task objects represented by the one or more predecessor nodes are completed.

Example 5. The method of any one of examples 1-4, further comprising after removing the invalid status of the completed task object represented by the selected node, removing, at runtime, the invalid status of the task objects represented by the contingent downstream nodes.

Example 6. The method of example 5, wherein removing the invalid status of the task objects represented by the contingent downstream nodes is contingent on a condition that the results of the completed task object represented by the selected node have not been changed since flagging the status of the completed task object represented by the selected node to be invalid.

Example 7. The method of any one of examples 1-6, wherein creating the entity close scheme comprises defining a planned start time for a first task object represented by a first node, wherein execution of the first task object starts at the planned start time on a condition that all predecessor task objects of the first task object have been completed at respective completion times before the planned start time, wherein the all predecessor task objects are respectively represented by all predecessor nodes of the first node.

Example 8. The method of any one of examples 1-7, wherein creating the entity close scheme comprises defining a trigger for a second task object represented by a second node, wherein the trigger causes the execution of the second task object to start at a last completion time on a condition that all predecessor task objects of the second task object have been completed at respective completion times, wherein the last completion time is the latest one of the completion times of all predecessor task objects, wherein the all predecessor task objects are respectively represented by all predecessor nodes of the second node.

Example 9. The method of any one of examples 1-8, wherein creating the entity close scheme comprises: identifying P predecessor nodes and S successor nodes that are interconnected by P×S edges therebetween, wherein P and S are greater than one; removing the P×S edges connecting the P predecessor nodes and S successor nodes; inserting a milestone node between the P predecessor nodes and S successor nodes, wherein the milestone node represents a pseudo task object having zero execution duration; creating P new edges connecting the P predecessor nodes to the milestone node; and creating S new edges connecting the milestone node to the S successor nodes.

Example 10. The method of example 9, further comprising changing the status of the pseudo task object, at a last completion time, to indicate a completion of the pseudo task object on a condition that the task objects represented by the P predecessor nodes have been completed at respective completion times, wherein the last completion time is the latest one of the completion times of the task objects represented by the P predecessor nodes.

Example 11. A computing system for improved entity close management, comprising: memory; one or more hardware processors coupled to the memory; and one or more computer readable storage media storing instructions that, when loaded into the memory, cause the one or more hardware processors to perform operations comprising: creating an entity close scheme comprising a plurality of nodes and edges connecting the plurality of nodes, wherein the nodes represent task objects with predefined timing conditions, and the edges define predecessor-successor relationship between pairs of nodes; executing the task objects represented by the nodes according to the predefined timing conditions of the task objects and the predecessor-successor relationship defined by the edges; monitoring status of the task objects during execution of the task objects; flagging the status of a completed task object represented by a selected node to be invalid based on evaluation of results of the completed task object; determining, at runtime, downstream nodes of the selected node, wherein a downstream node is connected to the selected node by one or more edges; identifying, at runtime, contingent downstream nodes among the downstream nodes of the selected node, wherein the edges connecting a contingent downstream node to the selected node have a contingent property, wherein the contingent property of an edge connecting a predecessor node to a successor node indicates that results of a task object represented by the successor node is contingent on results of a task object represented by the predecessor node; and flagging, at runtime, the status of task objects represented by the contingent downstream nodes to be invalid upon completion of the task objects represented by the contingent downstream nodes.

Example 12. The system of example 11, further comprising identifying, at runtime, non-contingent downstream nodes among the downstream nodes of the selected node, wherein a non-contingent downstream node is connected to one or more predecessor nodes that are either the selected node or downstream nodes of the selected node by edges with a non-contingent property, wherein the non-contingent property of an edge connecting a predecessor node to a successor node indicates that results of a task object represented by the successor node is not contingent on results of a task object represented by the predecessor node, wherein flagging the status of the completed task object represented by the selected node does not change the status of task objects represented by the non-contingent downstream nodes.

Example 13. The system of example 12, wherein execution of a task object represented by a successor node is disabled responsive to finding that the successor node is connected to at least one predecessor node by an edge having the contingent property, and status of a task object represented by the predecessor node indicates that the task object represented by the predecessor nodes is completed with an error.

Example 14. The system of any one of examples 12-13, wherein execution of a task object represented by a successor node is enabled responsive to finding that the successor node is connected to one or more predecessor nodes by edges having the non-contingent property, wherein status of the task objects represented by the one or more predecessor nodes indicate that the task objects represented by the one or more predecessor nodes are completed.

Example 15. The system of any one of examples 11-14, further comprising after removing the invalid status of the completed task object represented by the selected node, removing, at runtime, the invalid status of the task objects represented by the contingent downstream nodes.

Example 16. The system of example 15, wherein removing the invalid status of the task objects represented by the contingent downstream nodes is contingent on a condition that the results of the completed task object represented by the selected node have not been changed since flagging the status of the completed task object represented by the selected node to be invalid.

Example 17. The system of any one of examples 11-16, wherein creating the entity close scheme comprises defining a planned start time for a first task object represented by a first node, wherein execution of the first task object starts at the planned start time on a condition that all predecessor task objects of the first task object have been completed at respective completion times before the planned start time, wherein the all predecessor task objects are respectively represented by all predecessor nodes of the first node.

Example 18. The system of any one of examples 11-17, wherein creating the entity close scheme comprises defining a trigger for a second task object represented by a second node, wherein the trigger causes the execution of the second task object to start at a last completion time on a condition that all predecessor task objects of the second task object have been completed at respective completion times, wherein the last completion time is the latest one of the completion times of all predecessor task objects, wherein the all predecessor task objects are respectively represented by all predecessor nodes of the second node.

Example 19. The system of any one of examples 11-18, wherein creating the entity close scheme comprises: identifying P predecessor nodes and S successor nodes that are interconnected by P×S edges therebetween, wherein P and S are greater than one; removing the P×S edges connecting the P predecessor nodes and S successor nodes; inserting a milestone node between the P predecessor nodes and S successor nodes, wherein the milestone node represents a pseudo task object having zero execution duration; creating P new edges connecting the P predecessor nodes to the milestone node; and creating S new edges connecting the milestone node to the S successor nodes.

Example 20. One or more non-transitory computer-readable media having encoded thereon computer-executable instructions causing one or more processors, when programmed thereby, to perform a method for improved entity close management, comprising: creating an entity close scheme comprising a plurality of nodes and edges connecting the plurality of nodes, wherein the nodes represent task objects with predefined timing conditions, and the edges define predecessor-successor relationship between pairs of nodes; executing the task objects represented by the nodes according to the predefined timing conditions of the task objects and the predecessor-successor relationship defined by the edges; monitoring status of the task objects during execution of the task objects; flagging the status of a completed task object represented by a selected node to be invalid based on evaluation of results of the completed task object; determining, at runtime, downstream nodes of the selected node, wherein a downstream node is connected to the selected node by one or more edges; identifying, at runtime, contingent downstream nodes among the downstream nodes of the selected node, wherein the edges connecting a contingent downstream node to the selected node have a contingent property, wherein the contingent property of an edge connecting a predecessor node to a successor node indicates that results of a task object represented by the successor node is contingent on results of a task object represented by the predecessor node; and flagging, at runtime, the status of task objects represented by the contingent downstream nodes to be invalid upon completion of the task objects represented by the contingent downstream nodes, wherein creating the entity close scheme comprises: identifying P predecessor nodes and S successor nodes that are interconnected by P×S edges therebetween, wherein P and S are greater than one; removing the P×S edges connecting the P predecessor nodes and S successor nodes; inserting a milestone node between the P predecessor nodes and S successor nodes, wherein the milestone node represents a pseudo task object having zero execution duration; creating P new edges connecting the P predecessor nodes to the milestone node; and creating S new edges connecting the milestone node to the S successor nodes.

### Example 15—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method for improved entity close management, the method comprising:
creating an entity close scheme comprising a plurality of nodes and edges connecting the plurality of nodes, wherein the nodes represent task objects with predefined timing conditions, and the edges define predecessor-successor relationship between pairs of nodes;
executing the task objects represented by the nodes according to the predefined timing conditions of the task objects and the predecessor-successor relationship defined by the edges;
monitoring status of the task objects during execution of the task objects;
flagging the status of a completed task object represented by a selected node to be invalid based on evaluation of results of the completed task object;
determining, at runtime, downstream nodes of the selected node, wherein a downstream node is connected to the selected node by one or more edges;
identifying, at runtime, contingent downstream nodes among the downstream nodes of the selected node, wherein the edges connecting a contingent downstream node to the selected node have a contingent property, wherein the contingent property of an edge connecting a predecessor node to a successor node indicates that results of a task object represented by the successor node is contingent on results of a task object represented by the predecessor node; and
flagging, at runtime, the status of task objects represented by the contingent downstream nodes to be invalid upon completion of the task objects represented by the contingent downstream nodes.

2. The method of claim 1, further comprising identifying, at runtime, non-contingent downstream nodes among the downstream nodes of the selected node, wherein a non-contingent downstream node is connected to one or more predecessor nodes that are either the selected node or downstream nodes of the selected node by edges with a non-contingent property, wherein the non-contingent property of an edge connecting a predecessor node to a successor node indicates that results of a task object represented by the successor node is not contingent on results of a task object represented by the predecessor node, wherein flagging the status of the completed task object represented by the selected node does not change the status of task objects represented by the non-contingent downstream nodes.

3. The method of claim 2, wherein execution of a task object represented by a successor node is disabled responsive to finding that the successor node is connected to at least one predecessor node by an edge having the contingent property, and status of a task object represented by the predecessor node indicates that the task object represented by the predecessor nodes is completed with an error.

4. The method of claim 2, wherein execution of a task object represented by a successor node is enabled responsive to finding that the successor node is connected to one or more predecessor nodes by edges having the non-contingent property, wherein status of the task objects represented by the one or more predecessor nodes indicate that the task objects represented by the one or more predecessor nodes are completed.

5. The method of claim 1, further comprising after removing the invalid status of the completed task object represented by the selected node, removing, at runtime, the invalid status of the task objects represented by the contingent downstream nodes.

6. The method of claim 5, wherein removing the invalid status of the task objects represented by the contingent downstream nodes is contingent on a condition that the results of the completed task object represented by the selected node have not been changed since flagging the status of the completed task object represented by the selected node to be invalid.

7. The method of claim 1, wherein creating the entity close scheme comprises defining a planned start time for a first task object represented by a first node, wherein execution of the first task object starts at the planned start time on a condition that all predecessor task objects of the first task object have been completed at respective completion times before the planned start time, wherein the all predecessor task objects are respectively represented by all predecessor nodes of the first node.

8. The method of claim 1, wherein creating the entity close scheme comprises defining a trigger for a second task object represented by a second node, wherein the trigger causes the execution of the second task object to start at a last completion time on a condition that all predecessor task objects of the second task object have been completed at respective completion times, wherein the last completion time is the latest one of the completion times of all predecessor task objects, wherein the all predecessor task objects are respectively represented by all predecessor nodes of the second node.

9. The method of claim 1, wherein creating the entity close scheme comprises:
identifying P predecessor nodes and S successor nodes that are interconnected by P×S edges therebetween, wherein P and S are greater than one;
removing the P×S edges connecting the P predecessor nodes and S successor nodes;
inserting a milestone node between the P predecessor nodes and S successor nodes, wherein the milestone node represents a pseudo task object having zero execution duration;
creating P new edges connecting the P predecessor nodes to the milestone node; and
creating S new edges connecting the milestone node to the S successor nodes.

10. The method of claim 9, further comprising changing the status of the pseudo task object, at a last completion time, to indicate a completion of the pseudo task object on a condition that the task objects represented by the P predecessor nodes have been completed at respective completion times, wherein the last completion time is the latest one of the completion times of the task objects represented by the P predecessor nodes.

11. A computing system for improved entity close management, comprising:
memory;
one or more hardware processors coupled to the memory; and
one or more computer readable storage media storing instructions that, when loaded into the memory, cause the one or more hardware processors to perform operations comprising:
creating an entity close scheme comprising a plurality of nodes and edges connecting the plurality of nodes, wherein the nodes represent task objects with predefined timing conditions, and the edges define predecessor-successor relationship between pairs of nodes;
executing the task objects represented by the nodes according to the predefined timing conditions of the task objects and the predecessor-successor relationship defined by the edges;
monitoring status of the task objects during execution of the task objects;
flagging the status of a completed task object represented by a selected node to be invalid based on evaluation of results of the completed task object;
determining, at runtime, downstream nodes of the selected node, wherein a downstream node is connected to the selected node by one or more edges;
identifying, at runtime, contingent downstream nodes among the downstream nodes of the selected node, wherein the edges connecting a contingent downstream node to the selected node have a contingent property, wherein the contingent property of an edge connecting a predecessor node to a successor node indicates that results of a task object represented by the successor node is contingent on results of a task object represented by the predecessor node; and
flagging, at runtime, the status of task objects represented by the contingent downstream nodes to be invalid upon completion of the task objects represented by the contingent downstream nodes.

12. The system of claim 11, further comprising identifying, at runtime, non-contingent downstream nodes among the downstream nodes of the selected node, wherein a non-contingent downstream node is connected to one or more predecessor nodes that are either the selected node or downstream nodes of the selected node by edges with a non-contingent property, wherein the non-contingent property of an edge connecting a predecessor node to a successor node indicates that results of a task object represented by the successor node is not contingent on results of a task object represented by the predecessor node, wherein flagging the status of the completed task object represented by the selected node does not change the status of task objects represented by the non-contingent downstream nodes.

13. The system of claim 12, wherein execution of a task object represented by a successor node is disabled responsive to finding that the successor node is connected to at least one predecessor node by an edge having the contingent property, and status of a task object represented by the predecessor node indicates that the task object represented by the predecessor nodes is completed with an error.

14. The system of claim 12, wherein execution of a task object represented by a successor node is enabled responsive to finding that the successor node is connected to one or more predecessor nodes by edges having the non-contingent property, wherein status of the task objects represented by the one or more predecessor nodes indicate that the task objects represented by the one or more predecessor nodes are completed.

15. The system of claim 11, further comprising after removing the invalid status of the completed task object represented by the selected node, removing, at runtime, the invalid status of the task objects represented by the contingent downstream nodes.

16. The system of claim 15, wherein removing the invalid status of the task objects represented by the contingent downstream nodes is contingent on a condition that the results of the completed task object represented by the selected node have not been changed since flagging the status of the completed task object represented by the selected node to be invalid.

17. The system of claim 11, wherein creating the entity close scheme comprises defining a planned start time for a first task object represented by a first node, wherein execution of the first task object starts at the planned start time on a condition that all predecessor task objects of the first task object have been completed at respective completion times before the planned start time, wherein the all predecessor task objects are respectively represented by all predecessor nodes of the first node.

18. The system of claim 11, wherein creating the entity close scheme comprises defining a trigger for a second task object represented by a second node, wherein the trigger causes the execution of the second task object to start at a last completion time on a condition that all predecessor task objects of the second task object have been completed at respective completion times, wherein the last completion time is the latest one of the completion times of all predecessor task objects, wherein the all predecessor task objects are respectively represented by all predecessor nodes of the second node.

19. The system of claim 11, wherein creating the entity close scheme comprises:
identifying P predecessor nodes and S successor nodes that are interconnected by P×S edges therebetween, wherein P and S are greater than one;
removing the P×S edges connecting the P predecessor nodes and S successor nodes;
inserting a milestone node between the P predecessor nodes and S successor nodes, wherein the milestone node represents a pseudo task object having zero execution duration;
creating P new edges connecting the P predecessor nodes to the milestone node; and
creating S new edges connecting the milestone node to the S successor nodes.

20. One or more non-transitory computer-readable media having encoded thereon computer-executable instructions causing one or more processors, when programmed thereby, to perform a method for improved entity close management, comprising:
creating an entity close scheme comprising a plurality of nodes and edges connecting the plurality of nodes, wherein the nodes represent task objects with predefined timing conditions, and the edges define predecessor-successor relationship between pairs of nodes;
executing the task objects represented by the nodes according to the predefined timing conditions of the task objects and the predecessor-successor relationship defined by the edges;
monitoring status of the task objects during execution of the task objects;
flagging the status of a completed task object represented by a selected node to be invalid based on evaluation of results of the completed task object;
determining, at runtime, downstream nodes of the selected node, wherein a downstream node is connected to the selected node by one or more edges;
identifying, at runtime, contingent downstream nodes among the downstream nodes of the selected node, wherein the edges connecting a contingent downstream node to the selected node have a contingent property, wherein the contingent property of an edge connecting a predecessor node to a successor node indicates that results of a task object represented by the successor node is contingent on results of a task object represented by the predecessor node; and
flagging, at runtime, the status of task objects represented by the contingent downstream nodes to be invalid upon completion of the task objects represented by the contingent downstream nodes,
wherein creating the entity close scheme comprises:
identifying P predecessor nodes and S successor nodes that are interconnected by P×S edges therebetween, wherein P and S are greater than one;
removing the P×S edges connecting the P predecessor nodes and S successor nodes;
inserting a milestone node between the P predecessor nodes and S successor nodes, wherein the milestone node represents a pseudo task object having zero execution duration;
creating P new edges connecting the P predecessor nodes to the milestone node; and
creating S new edges connecting the milestone node to the S successor nodes.
